(19) United States
(12) Patent Application Publication
(10) Pub. No.: US 2017/0230367 A1
(43) Pub. Date: Aug. 10, 2017

(54) AUTHENTICATION OF COMMUNICATION UNITS

(71) Applicant: Silent Circle, SA, Geneva (CH)

(72) Inventors: Jason A. COOPER, Chesapeake, VA (US); Jonathan D. CALLAS, San Jose, CA (US)

(21) Appl. No.: 15/040,504

(22) Filed: Feb. 10, 2016

(51) Int. Cl. H04L 29/06; H04L 29/08

(52) U.S. Cl. CPC H04L 63/0884; H04L 67/104

(57) ABSTRACT

Techniques concerning the authentication of communication units in a network of communication units are disclosed. At the request of an initiating communication unit, an intermediate communication unit generates a first authentication problem and a first authentication answer that are answerable by a target communication unit. The first authentication answer is provided to the initiating communication unit and the first authentication problem is provided to a target communication unit. The target communication unit provides a first proposed answer to the initiating communication unit. When the first proposed answer compares favorably with the first authentication answer, the initiating communication unit designates the target communication unit as being authenticated. This process may be repeated with the roles of the initiating and target communication units reversed in order to authenticate the initiating communication unit to the target communication unit.

### CROSS-REFERENCE TO RELATED APPLICATION

The instant application is related to co-pending application entitled “INTER-COMMUNICATION UNIT MESSAGE ROUTING AND VERIFICATION OF CONNECTIONS” having attorney docket number 48702.00.0002, filed on even date herewith.

### FIELD

The instant disclosure relates generally to communication networks and, in particular, to authentication of communication units within such networks.

### BACKGROUND

Securing the privacy and integrity of communications has become an issue of increasing importance in recent years, particularly over networks of entities communicating with each other. An example of such a communication network is illustrated in FIG. 1 in which a plurality of endpoints or communication units, labeled A-F, have a corresponding plurality of connections 102 therebetween. Generally, a communication unit may be considered any processing-capable device capable of supporting the communication protocols necessary for communicating with another communication unit. For example, in the case of the Internet, centrally-managed, cryptographic techniques such as public key infrastructure (PKI) in cooperation with the Secure Sockets Layer (SSL) and Transportation Layer Security (TLS) protocols have been used for many years for both authentication and verification purposes. As used herein, authentication is the determination of identity, i.e., that a given communication unit is, in fact, the communication unit known within a network of communication units. Verification, on the other hand, is a determination that a so-called man-in-the-middle (MitM) attack is not occurring between two communication units, an example of which illustrated in FIG. 2. As shown in FIG. 2, a MitM attacker 202 is able to intercept messages sent between two communication units A, B over respective connections 204a, 204b that, from the perspective of the affected communication units A, B, appear to be a single connection terminated by each other when, in fact, they are terminated by the MitM attacker 202. Particularly, is this example, the MitM attacker 202 effectively implements two separate communication units X1, X2 each of which is capable of cryptographically communicating with corresponding ones of the affected communication units A, B. Thus, the MitM attacker 202 can decrypt any encrypted messages sent by the affected communication units A, B in order to monitor and, if desired, re-encrypt such messages or substitute and encrypt its own messages. In this manner, the affected communication units A, B believe they are securely communicating with each other when, in fact, all of their communications are susceptible to monitoring and tampering.

While existing authentication and verification techniques have proved serviceable, the administrative burden to implement such technologies can be significant and various cryptographic weaknesses of such systems have been found. More recently, techniques have been developed that eliminate the need for centralized cryptographic implementation. For example, the Pretty Good Privacy (PGP) program, building on the use of public and private encryption keys, permits endpoints to establish their own cryptographic communications without the need for centralized management. Though not required, authentication of individual users is advisable to ensure that a public key used to send messages to that user is actually associated with him/her. While manually-implemented techniques exist for ensuring such authentication, many users are simply not interested in performing them.

Another example of a distributed cryptographic technique is the Zimmerman Real-Time Transport Protocol (ZRTP) more fully described in U.S. Pat. No. 7,730,309, the teachings of which are incorporated herein by this reference. ZRTP provides end-to-end verification of voice over IP (VoIP) communications through establishment of shared secrets that serve as the basis for ephemeral session keys and inter-session key continuity. Based on these features, in which encryption keys for a given session expire after that session and are further used to establish the encryption keys used in a subsequent session, all subsequent sessions between two communication units can proceed with the assurance that a MitM attack is not occurring unless such a MitM attack was established during the initial session and ZRTP setup between the communication units. To further prevent MitM attacks, ZRTP also incorporates use of so-called short authentication strings (SASs) that are derived from session keys and permit oral comparison to ensure continuing verification context. While effective, ZRTP is arguably vulnerable if users are not diligent in ensuring ongoing verification context, i.e., comparing SASs each session. Additionally, use of SASs every time a new connection is established between endpoints could become burdensome, particularly when one considers the frequency with which user tend change devices. Further still, the use of effective techniques like SASs is not an option for typically unattended endpoints, i.e., the Internet of Things, where a use is unable perform an oral confirmation of a SAS.

Thus, it would be advantageous to provide techniques that address the shortcomings of existing technologies.

### SUMMARY

The instant disclosure describes various techniques concerning the authentication of communication units in a network of communication units. In an embodiment, an initiating communication unit sends an authentication request, including an identifier of a target communication unit, to a first intermediate communication unit that the initiating communication unit has previously designated as authenticated. Thereafter, the initiating communication unit receives, in response to the authentication request, a first authentication answer to a first authentication problem from the intermediate communication unit. The first authentication problem is answerable by the target communication unit based on authentication of the target communication unit to the intermediate communication unit. In an alternate embodiment, the initiating communication unit also receives the first authentication problem from the first intermediate communication unit and sends the first authentication problem to the target communication unit. Regardless, the initiating communication unit receives a first proposed answer to the first authentication problem from the target communication unit. When the first authentication answer compares favorably with the first proposed answer, the initiating communication unit designates the target communication unit as being authenticated. This process may be repeated with the roles of the initiating and target communication units reversed based on a second authentication problem generated by an intermediate communication unit on behalf of the target communication unit, thereby permitting the initiating communication unit to be authenticated to the target communication unit.

In order to identify the first intermediate communication unit, the initiating communication unit can send a request to the target communication unit for a list of authenticated peers and compare that first list with a second list of communication units that are authenticated to the initiating communication unit. A communication unit identified in both the first and second lists may be used as the first intermediate communication unit. In an embodiment, the first authentication answer is based on a first shared secret between the first intermediate communication unit and the target communication unit. In an embodiment, the first authentication problem is encrypted data such that the first authentication answer is decrypted data based on the first shared secret. The first authentication problem may also comprise a data structure with the first authentication answer comprising a first message authentication code based on the data structure and the first shared secret.

In another embodiment, the target communication unit receives the first authentication problem from either the initiating communication unit or the intermediate communication unit. In response, the target communication unit determines the first proposed answer and sends it to the initiating communication unit. Additionally, the target communication unit may receive a request for a list of authenticated peers from the initiating communication unit and thereafter reply to the initiating communication unit with a first list of communication units that are authenticated to the target communication unit. Once again, in an embodiment, the roles of the target and initiating communication units can be reversed whereby this process is repeated by the initiating communication unit in order to authenticate the initiating communication unit to the target communication unit.

In yet another embodiment, the intermediate communication unit receives the first authentication request from the initiating communication unit and, in response, generates the first authentication problem and the first authentication answer. The intermediate communication unit then sends the first authentication answer to the initiating communication unit. In alternate embodiments, the intermediate communication unit sends the first authentication problem to either the initiating communication unit or the target communication unit. Once again, this same process may be repeated by the intermediate communication unit in which the roles of the initiating and target communication units is reversed in order to authenticate the initiating communication unit to the target communication unit.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a schematic illustration of a network of communication units in accordance with prior art techniques;

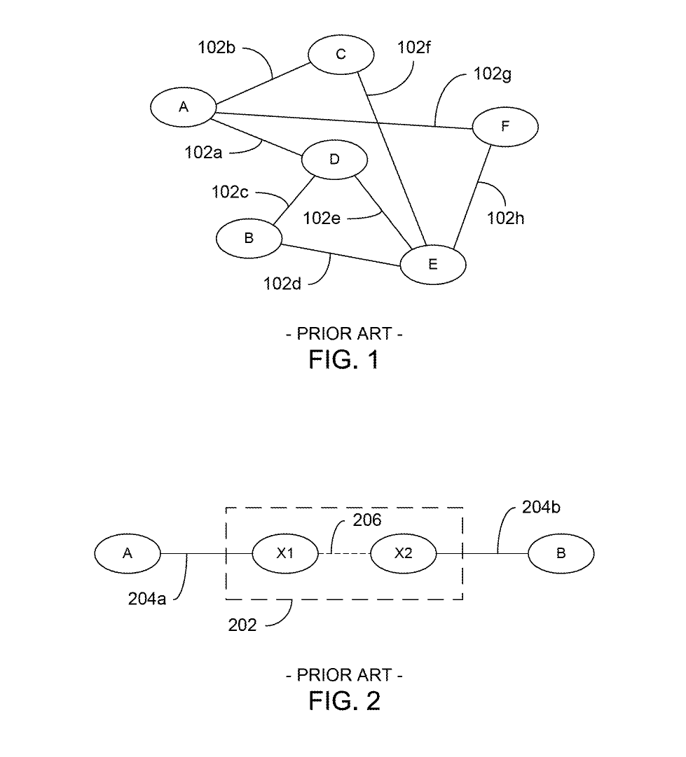

FIG. 2 is a schematic illustration of a man-in-the-middle attack in accordance with prior art techniques; and

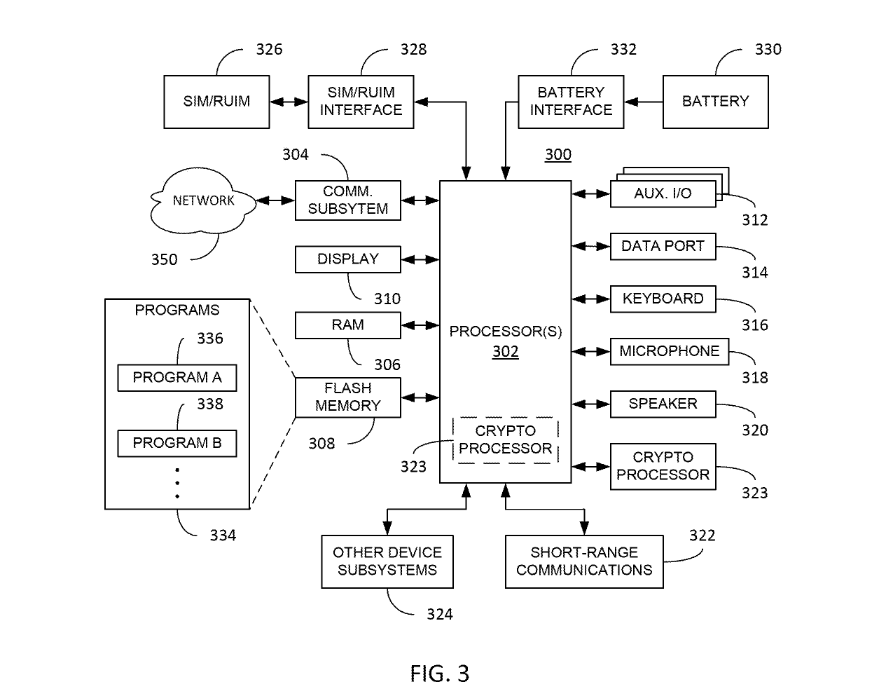

FIG. 3 is a block diagram illustrating an example of a communication unit in accordance with the instant disclosure;

FIG. 4 is a flow chart illustrating verification operation of an initiating communication unit in accordance with the instant disclosure;

FIG. 5 is a flow chart illustrating routing and verification operation of an intermediate communication unit in accordance with the instant disclosure;

FIGS. 6-8 illustrate an example of routing and verification operation in accordance with the instant disclosure;

FIG. 9 is a flow chart illustrating authentication operation of an initiating communication unit in accordance with the instant disclosure;

FIG. 10 is a flow chart illustrating in greater detail identification of an intermediate communication unit by an initiating communication unit during authentication operation in accordance with the instant disclosure;

FIG. 11 is a flow chart illustrating authentication operation of an intermediate communication unit in accordance with the instant disclosure;

FIG. 12 is a flow chart illustrating authentication operation of a target communication unit in accordance with the instant disclosure; and

FIGS. 13-19 illustrate examples of authentication operation in accordance with the instant disclosure.

### DETAILED DESCRIPTION OF THE PRESENT EMBODIMENTS

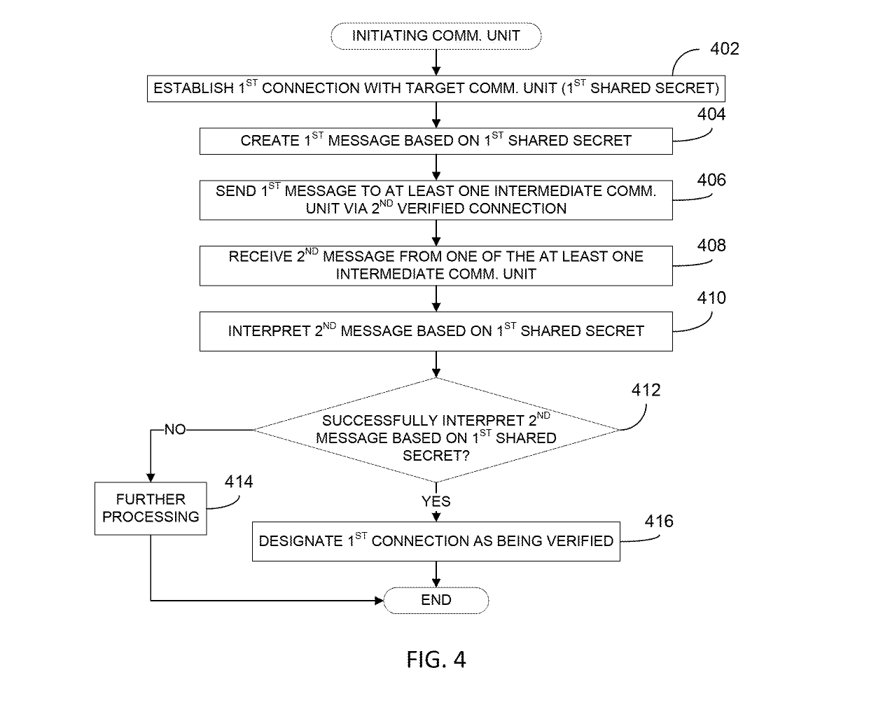

Referring now to FIG. 3, an example configuration for communication unit 300 is illustrated in block diagram form. The communication unit 300 comprises a number of components such as a main processor 302 that controls the overall operation of the communication unit 300. Communication functions, including data and voice communications, are performed through a communication subsystem 304. The communication subsystem 304 implements various communication protocols that all it to receive messages from and send messages to a wireless network 350. For example, the communication subsystem 304 may be configured in accordance with the well-known GSM (Global System for Mobile Communications) and GPRS (General Packet Radio Service) standards. Other communication configurations that are equally applicable include the so-called 3G and 4G telecommunication networks known in the art. As will be appreciated by those of skill in the art, new standards are still being defined that are likely to have functional similarities to the network behavior described herein, and it is understood that the embodiments described herein are intended to use any other suitable standards that are developed in the future. The wireless link connecting the communication subsystem 304 with the wireless network 350 represents one or more different Radio Frequency (RF) channels, operating according to defined protocols specified for GSM/GPRS communications.

The main processor 302 also interacts with additional subsystems such as a Random Access Memory (RAM) 306, a flash memory 308, a display 310, an auxiliary input/output (I/O) subsystem 312, a data port 314, a keyboard 316, a speaker 320, a microphone 318, short-range communications 322, and other device subsystems 324. The short-range communications 322 can implement any suitable or desirable device-to-device or peer-to-peer communications protocol capable of communicating at a relatively short range, e.g. directly from one device to another. Examples include “BLUETOOTH”, ad-hoc WiFi, infrared, or any “long-range” protocol re-configured to utilize available short-range components. It will therefore be appreciated that short-range communications 322 may represent any hardware, software or combination of both that enable a communication protocol to be implemented between devices or entities in a short range scenario, such protocol being standard or proprietary.

Some of the subsystems of the communication unit 300 perform communication-related functions, whereas other subsystems may provide “resident” or on-device functions. By way of example, the display 310 and the keyboard 316 may be used for both communication-related functions, such as entering a text message for transmission over the network 350, and device-resident functions such as a calculator or task list.

The communication unit 300 can send and receive communication signals over the wireless network 350 after required network registration or activation procedures have been completed. Network access is associated with a subscriber or user of the communication unit 300. To identify a subscriber, the communication unit 300 may use a subscriber module component or “smart card” 326, such as a Subscriber Identity Module (SIM), a Removable User Identity Module (RUIM) and a Universal Subscriber Identity Module (USIM). In the example shown, a SIM/RUIM/USIM 326 can be inserted into a SIM/RUIM/USIM interface 328 in order to communicate with a network. Without the component 326, the communication unit 300 is not fully operational for communication with the wireless network 350. Once the SIM/RUIM/USIM 326 is inserted into the SIM/RUIM/USIM interface 328, it is coupled to the main processor 302.

The communication unit 300 is typically a battery-powered device and in this example includes a battery interface 332 for receiving one or more rechargeable batteries 330. In at least some embodiments, the battery 330 can be a smart battery with an embedded microprocessor. The battery interface 332 is coupled to a regulator (not shown), which assists the battery 330 in providing power V+ to the communication unit 300. Although current technology makes use of a battery, future technologies such as micro fuel cells may provide the power to the communication unit 300.

In the examples described herein, the communication unit 300 comprises or otherwise has access to a cryptographic processor 323 which can be embodied in hardware, software, or a combination of the two. Also, as will be discussed below, the cryptographic processor 323 may control or include a software-based cryptographic module or application that cryptographically processes data. The communication unit 300 may also comprise internal or external memory or other machine-readable media for storing executable instructions that may be executed by the processor(s) 302 including, but not limited to, enabling the cryptographic processor 323 to perform cryptographic operations as is known in the art. As can be seen in FIG. 3, the cryptographic processor 323 may be independent of the main processor 302 in a mobile device configuration, or may be implemented by special instructions or hardware associated with the main processor 302 itself.

The communication unit 300 may also optionally include an operating system 334 and a plurality of software components 336, 338. The operating system 334 and the software components 336, 338 that are executed by the main processor 302 are typically stored in a persistent or non-volatile store such as the flash memory 308, which may alternatively be a read-only memory (ROM) or similar storage element (not shown). Those skilled in the art will appreciate that portions of the operating system 334 and the software components 336, 338, such as specific device applications, or parts thereof, may be temporarily loaded into a volatile storage devices such as the RAM 306. Other software components can also be included, as is well known to those skilled in the art.

The data port 314 can be any suitable port that enables data communication between the communication unit 300 and another computing device. The data port 314 can be a serial or a parallel port. In some instances, the data port 314 can be a USB (Universal Serial Bus) port that includes data lines for data transfer and a supply line that can provide a charging current to charge the battery 330 of the communication unit 300.

For voice communications, received signals are output to the speaker 320, and signals for transmission are generated by the microphone 318. Although voice or audio signal output is accomplished primarily through the speaker 320, the display 310 can also be used to provide additional information such as the identity of a calling party, duration of a voice call, or other voice call related information.

For composing data items, such as e-mail messages, for example, a user or subscriber could use a touch-sensitive overlay (not shown) on the display 310 that is part of a touch screen display (not shown), in addition to possibly the auxiliary I/O subsystem 312. The auxiliary I/O subsystem 312 may include devices such as: a mouse, track ball, infrared fingerprint detector, or a roller wheel with dynamic button pressing capability. A composed item may be transmitted over the wireless network 350 through the communication subsystem 304.

As noted above, the software applications 336, 338 stored in flash memory 308 (or the like) may include a cryptographic module that comprises or otherwise has access to a portion of memory, database or other data storage device for the storage of any data or information associated with the cryptographic capabilities of various communication units, as described in further detail below.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the communication unit 300 or accessible or connectable thereto. Any processing described herein may be implemented using computer readable/executable instructions that may be stored or otherwise held by such computer readable media.

Furthermore, while the communication unit 300 has been described herein primarily in terms of a mobile, wireless device, the instant disclosure is not necessarily limited in this regard. In particular, as used herein, a communication unit may comprise some lesser level of hardware, software or functionality than that described relative to FIG. 3 without departing from the basic communication capabilities described above. For example, where physical objects are equipped with communication capability that does not require voice communications (as in the case, for example, of a device operating within the so-called Internet of Things (IoT)), components such as the microphone 318, speaker 320, etc. may be excluded from the communication unit integral to or embedded within such physical objects. As another example, such physical objects may have access to convention mains power that may be used to provide power to the communication unit, thereby obviating the need for the battery 330 or battery interface 332. As yet another example, rather than relying on a wireless communication subsystem 304 or wireless short-range communications 322, the communication unit could be equipped with a wired communication subsystem in order to interface with, for example, the public switched telephone network (PSTN). Those having skill in the art that other forms of embedded or integrated communication units that remain capable of performing the processing described herein may be employed as a matter of design choice.

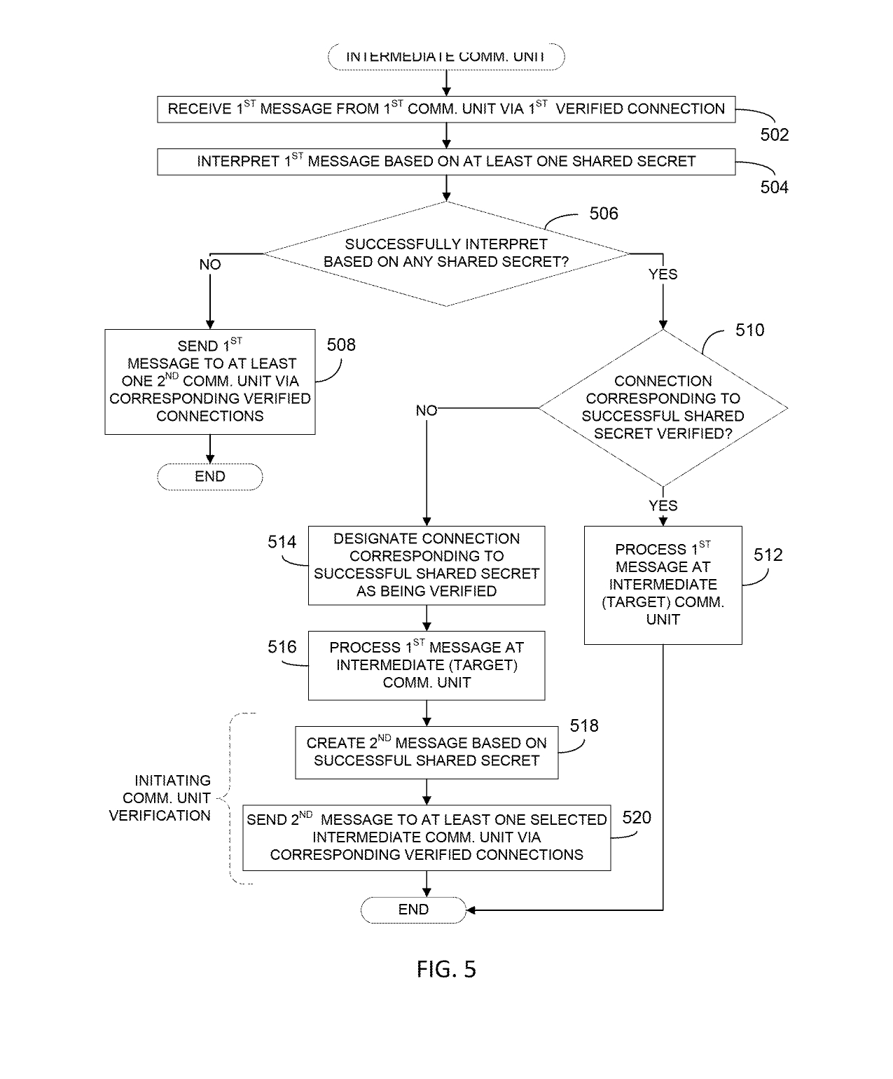

Various processing operations in accordance with the instant disclosure are described below with reference to FIGS. 4-19. As used herein, including the descriptions below, an initiating communication unit comprises any communication unit that generates a request to initiate communications--whether voice or data--with another communication unit. Oppositely, a target communication unit comprises an communication unit that receives, from another communication unit, a request to initiate communications of any type with that other communication unit. An intermediate communication unit comprises a communication unit that minimally has an already-existing, verified connection with an initiating communication unit and, in some embodiments described below, may further have a verified connection with a target unit associated with the initiating communication unit. Furthermore, a connection between two communication units may comprise not only a “physical” communication channel (as needed) but also a logical channel in which communications between the endpoints of the connection experience the benefits of a ZRTP-type connection, i.e., shared secrets known to the endpoints, session key continuity, ephemeral session keys, etc. In particular, and as used herein, a given connection and a shared secret established at the time of that connection's creation are assumed to correspond to each other such the reference to one is assumed to imply the other.

Referring now to FIG. 4, verification processing by an initiating communication unit is further described. That is, the processing illustrated in FIG. 4 concerns those steps taken by an initiating communication unit to verify a connection with a target communication unit. Thus, beginning at block 402, the initiating communication unit establishes a first connection with a target communication unit, including establishment of a first shared secret known to both the initiating and target communication units. For example, in an embodiment, the initiating and target communication units may employ the Ephemeral Elliptic Curve, Diffie-Hellman Exchange (ECDHE) key negotiation process used in ZRTP to create an encryption key known to both the initiating and target communication units, referred to herein as a shared secret. As described above, each pairwise association of an initiating and target communication unit may utilize this approach to establish shared secrets therebetween. Consequently, each connection between two communication units may have a shared secret associated therewith and, in practice, any given communication unit in this scenario will thus maintain a plurality of shared secrets for each such connection that it may have. Although the ECDHE key negotiation process noted above may be employed for the establishment of shared secrets, those having skill in the art will appreciate that this is not a requirement as any suitable technique that similarly results in shared secrets may be employed.

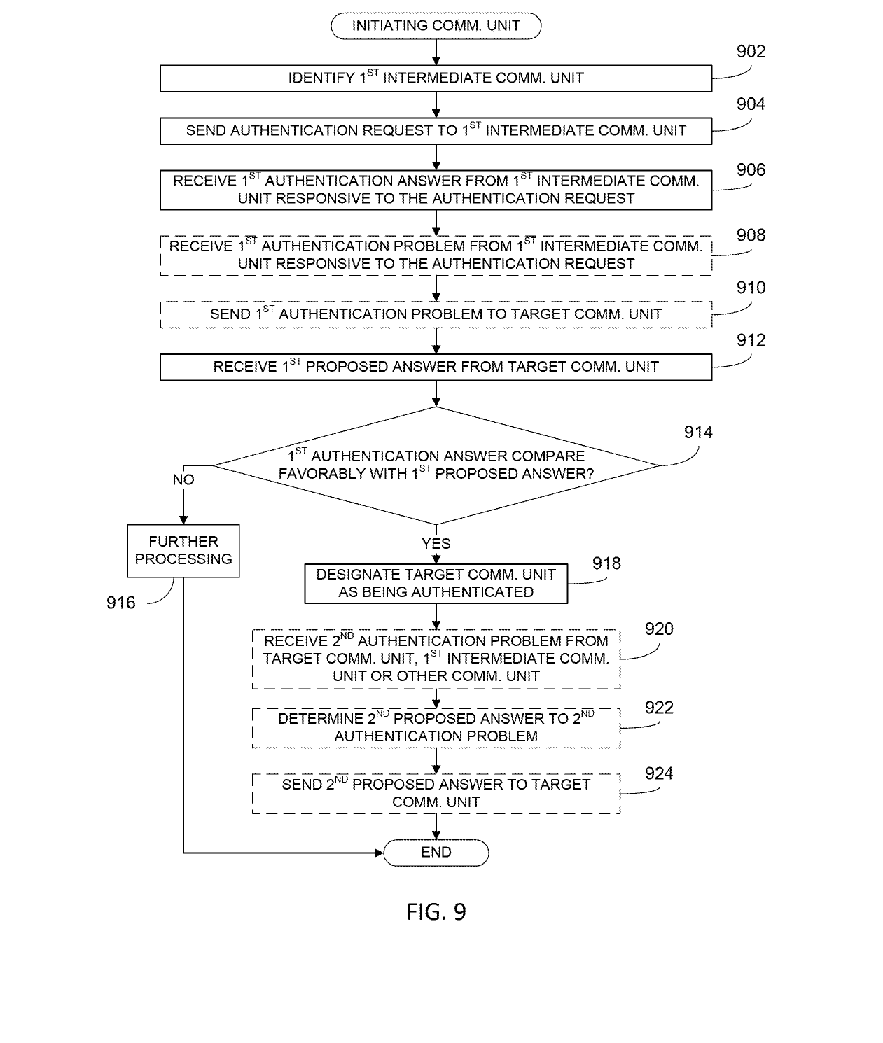

Referring once again to FIG. 4, processing continues at block 404 where the initiating communication unit creates a first message based on the first shared secret. Because the first shared secret is also known to the target communication unit, it should be able to successfully interpret the first message. In an embodiment, the first message may actually comprise a first encrypted message in which plaintext is encrypted based on a suitable encryption technique (such as, but not limited to, Authenticated Encryption with Associated Data (AEAD)) and the first shared secret. Additionally, the first message may also comprise a message authentication code (MAC) based on the first message (whether in plaintext or ciphertext form) and the first shared secret. For example, MACs used for this purpose may comprise Hash-Based Authentication Codes, though the instant disclosure is not limited in this regard. Regardless, thereafter at block 406, the initiating communication unit sends the first message to at least one intermediate communication unit, wherein each of the at least one intermediate communication unit has a corresponding connection that has been previously designated by the initiating communication unit as being verified. By sending the first message to one or more intermediate communication units, the initiating communication unit is essentially attempting to use the verified connections already existing in the network to act as a trusted second (or back) channel to the target communication unit in an effort to automatically verify the target communication unit. An example of this is illustrate in FIG. 6.

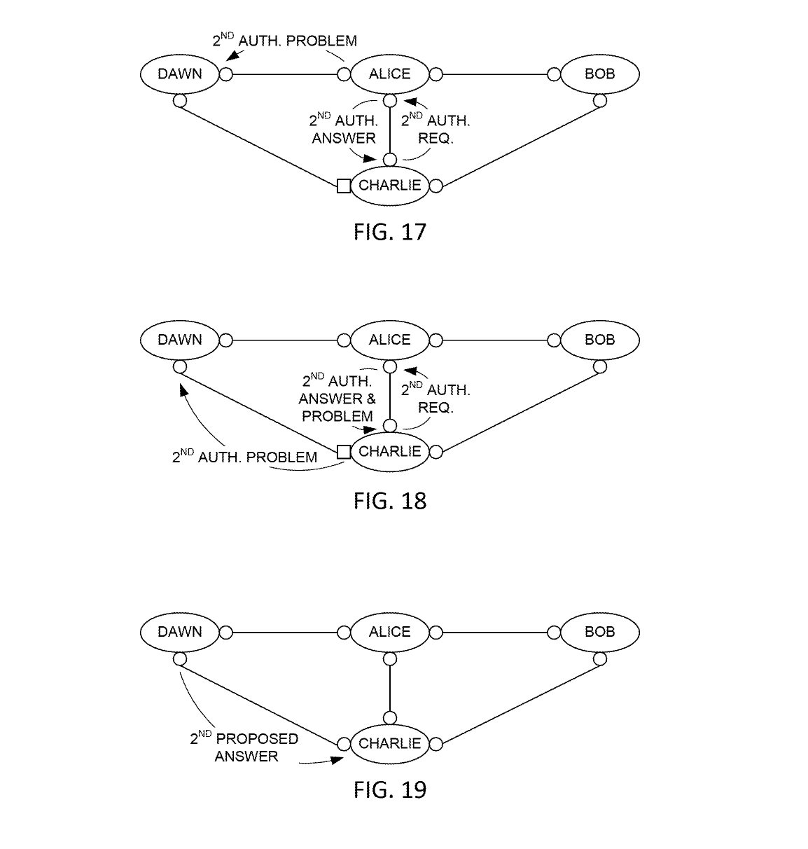

In FIG. 6, a simplified network of communication units (labeled “Alice,” “Bob,” “Charlie” and “Dawn”) is shown in which authenticated and verified connections between Alice and Bob, Alice and Charlie, Bob and Charlie and Alice and Dawn are assumed to have been previously established. It is noted that FIGS. 6-8 (as well as FIGS. 13-19) employ a convention in which circles associated with a given communication unit and terminating a connection are used to illustrate the fact that the communication unit associated with a circle has been authenticated to the other communication unit terminating that connection. In turn, squares used in this manner indicate that the associated communication unit has not been authenticated to the other communication unit terminating that connection. Further still, shading or cross-hatching of these connection terminators—whether squares or circles—indicates that the associated communication unit has not yet designated the connection as being verified, whereas solid white connection terminators indicate that the associated communication has designated the connection as being verified. In implementation, the designation of a connection as being verified or the designation of a communication as being authenticated may be performed through the setting of an appropriate value corresponding to the relevant connection/shared secret and/or communication unit in a persistent memory location implemented by the designating communication unit.

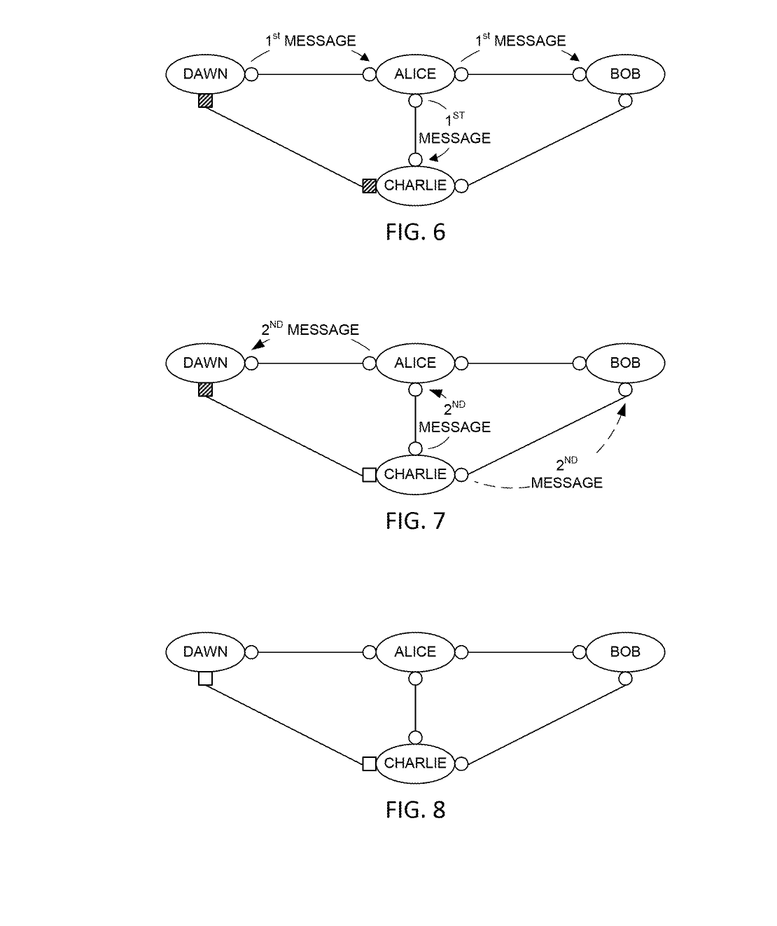

For example, in FIG. 6, the pre-existing, authenticated and verified Alice-Bob, Alice-Charlie and Bob-Charlie connections are illustrated as being terminated by solid, white circles. In contrast, the newly established Dawn-Charlie connection (as described above at block 402) is illustrated with shaded, square connection terminators, indicating the fact that the neither Dawn or Charlie have yet verified the connection, and that Dawn has not yet been authenticated to Charlie and vice-versa. In this example, in which it is assumed that Dawn is the initiating communication unit and Charlie is the target communication unit, the sole intermediate communication unit available to Dawn is Alice. In practice, however, it is likely that any given communication unit will, over time, have multiple such intermediate communication units available, e.g., Alice and Charlie are both intermediate communication units to Bob. Regardless, having established the unverified connection with Charlie, Dawn sends a first message (as described above) to Alice. Alice, as an intermediate communication unit, will process the first message in order to determine whether it (Alice) was the intended recipient of the first message or, if not, whether to forward the first message on to other communication units in the network having validated connections with Alice (described in further detail below with reference to FIG. 5).

Referring once again to FIG. 4, from the point of view of the initiating communication unit and subsequent to sending the first message to the at least one intermediate communication unit, a second message is received from the at least one intermediate communication unit at block 408. At block 410, the initiating communication unit interprets the second message based on the shared secret. As used herein, interpretation of a message based on a shared secret means that the communication unit attempts to determine whether the message was originally created in accordance with that shared secret. For example, in the case of the second message comprising ciphertext, interpretation of the second encrypted message comprises attempting to decrypt the message based on the shared secret. In this case, the message is successfully interpreted if the resulting plaintext is understandable. As another example, where the second message comprises a received message authentication code determined according to the shared secret, the communication unit may determine a computed message authentication code based on the received second message (whether encrypted or not) and the shared secret. A comparison is then made between the received and computed message authentication codes. If the received and computed message authentication codes match, then the second message is deemed successfully interpreted. Other interpretation schemes of the type described here will be apparent to those having skill in the art.

Thus, at block 412, a determination is made whether the second message has been successfully interpreted based on the first shared secret. If not, then processing continues at block 414 where the second message is further processed as in the case that the initiating communication unit is serving in the role of an intermediate communication unit, as described in further detail below. If the second message is successfully interpreted at block 412, processing continues at block 416 where the first connection between the initiating and target communication units is designated by the initiating communication unit as being verified.

An example of this is further illustrated with reference to FIGS. 7 and 8. In FIG. 7, Alice, acting as the intermediate communication unit sends the second message (originated by the target communication unit, Charlie, after receiving and successfully interpreting the first message sent by Dawn, as described in further detail below) to Dawn. In turn, when Dawn successfully interprets the second message based on the first shared secret, Dawn designates the connection with Charlie as being verified. This is illustrated in FIG. 8 where the connection terminator for Dawn terminating the connection with Charlie is now illustrated without the shading. Note that Dawn's terminator for the connection with Charlie is still illustrated as a square in this case as Charlie has not yet been authenticated to Dawn.

Referring now to FIG. 5, verification processing by an intermediate communication unit is further described. That is, the processing illustrated in FIG. 5 concerns those steps taken by an intermediate communication unit to verify a connection with a target communication unit. A particular feature of the processing performed by any communication unit that receives a message for purposes of verification is that such communication unit will operate as an intermediate communication unit until such time as it determines that it is, in fact, the target communication unit for that message. In this sense, the description of various communication units as initiating, intermediate or target communication units is a labeling convention employed for ease of explanation. In practice, the circumstances concerning each determination of successful message interpretation determines the effective label to be applied to any given communication unit.

With this in mind, processing begins at block 502 where an intermediate communication unit receives a first message from a first communication unit. Note that no assumption is made in FIG. 5 that the first communication unit is an initiating communication unit, a target communication unit or even another intermediate communication unit. Thereafter, at block 504, the intermediate communication unit attempt to interpret the first message based on at least one shared secret in its possession. Thereafter, at block 506, a determination is made if any of the at least one shared secrets maintained by the intermediate communication unit were successfully employed to interpret the first message. If none of the shared secrets were successful, then processing continues at block 508 where the intermediate communication unit sends the first message to at least one second intermediate communication unit where, once again, each of the at least one second intermediate communication units has a connection with the intermediate communication unit previously designated by the intermediate communication unit as being verified. An example of this is illustrated in FIG. 6.

In FIG. 6, Alice, as the intermediate communication unit receives the first message from Dawn. Being unable to successfully interpret the first message based on any shared secrets in its possession, Alice then forwards the first message to those communication units having connections with Alice that Alice has previously designated as verified, i.e., Bob and Charlie. Bob and Charlie, in turn, will likewise operate as intermediate communication units, i.e., also in accordance with the processing illustrate in FIG. 5. In this sense, the authenticated connections within the network are acting in a “viral” manner to communicate the first message to its proper recipient, i.e., they route the message within the boundaries of any verified connections in the network. As will be appreciated by those of skill in the art, well-known time to live (TTL) mechanisms, such as hop counters or time stamps, may be employed to prevent messages as described herein from indefinitely propagating through the network's verified connections.

Referring once again to FIG. 5, if the determination is made at block 506 that one of the shared secrets maintained by the intermediate communication unit was successful at interpreting the first message, then the intermediate effectively knows at this point that it was the intended recipient (i.e., the target communication unit) of the first message. Thus, it is further determined at block 510 whether a connection corresponding to the successful shared secret (i.e., that shared secret that was able to successfully interpret the first message) has been previously verified. In other words, it may be that the first message is actually an attempt by another communication unit (corresponding to the successful shared secret and associated connection) to verify its connection with the given “intermediate” communication unit. If it is determined at block 510 that the connection corresponding to the successful shared secret has previously been designated as verified, the processing continues at block 512 where the first message is further processed at the intermediate (now, effectively deemed the target) communication unit in the sense that the first message is handled according to its type. For example, in the case that the first message comprises a text message or the like intended for the user of the intermediate (target) communication unit, the processing at block 512 may comprise rendering the text message on a display of the intermediate (target) communication unit.

On the other hand, if it is determined at block 510 that the connection corresponding to the successful shared secret has not been previously verified, then processing continues at block 514. In this case, then, the first message is an attempt by another communication unit to verify its connection with the intermediate (target) communication unit. Thus, at block 514, the intermediate (target) communication unit designates the connection corresponding to the successful shared secret as being verified and, at block 516, further processes the first message in the same manner, as necessary, as described above relative to block 512. An example of this is illustrate in FIGS. 6 and 7, where Charlie, after receiving and successfully interpreting the first message (FIG. 6), subsequently designates the connection with Dawn as being verified. Once again, this is illustrated in FIG. 7 where the connection terminator for Charlie terminating the connection with Dawn is now illustrated without the shading. Once again, it is noted that Charlie's terminator for the connection with Dawn is still illustrated as a square because Dawn has not yet been authenticated to Charlie.

As noted previously with regard to FIG. 4, part of the verification process for the initiating communication unit is receiving a similar verification message from the target communication unit to order to verify the corresponding connection from the initiating communication unit's point of view. This is illustrated in FIG. 5 at blocks 518 and 520. At block 518, the intermediate (target) communication unit creates a second message based on the successful shared secret and, at block 520, sends the second message to at least one selected intermediate communication unit where, once again, each of the at least one selected intermediate communication units has a connection with the intermediate (target) communication unit previously designated by the intermediate (target) communication unit as being verified. In an embodiment, the at least one selected intermediate communication unit may include an intermediate communication unit other than the one from which the first message was received, which can improve overall security in the event of a potentially compromised intermediate communication unit. An example of this is illustrated in FIG. 7 where, Charlie, having determined that it was the target communication unit of the first message sent by Dawn (FIG. 6), sends a second message to Alice and Bob. As shown, the at least one selected intermediate communication unit will, at minimum, include the intermediate communication unit from which the first message was received, i.e., Alice. However, as further shown in FIG. 7, the at least one selected intermediate communication unit can include other intermediate communication units from which the first message was not received, i.e., Bob.

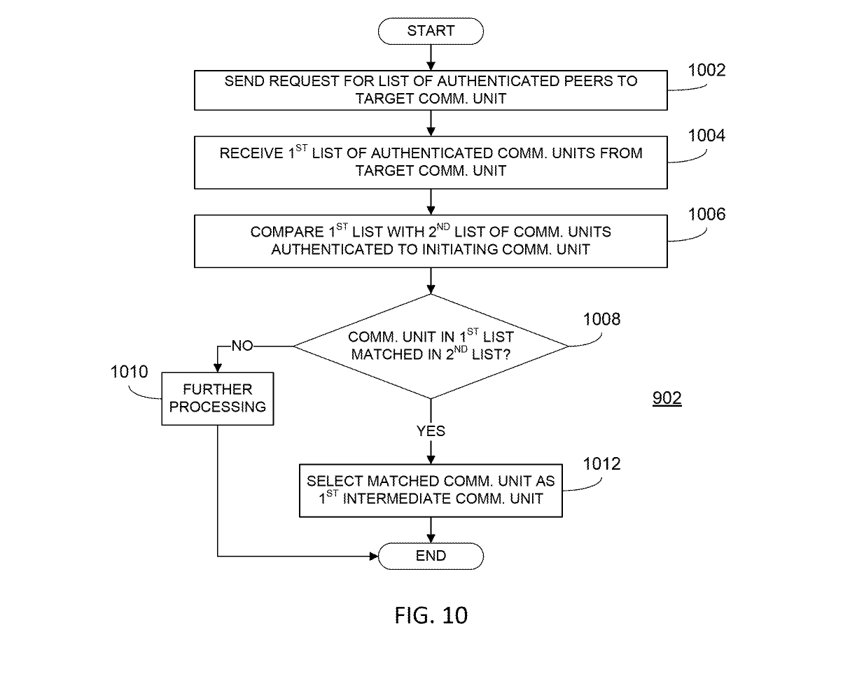

The techniques illustrated with reference to FIGS. 4-8 describe the use of verified connections within a network of communication units in order to automatically verify new connections within the network. However, as noted in the examples of FIGS. 6-8, verification of a connection does not necessarily lead to authentication of one communication unit to another. To the end, further processing for the purpose of authenticating communication units is further described below with reference to FIGS. 9-19.

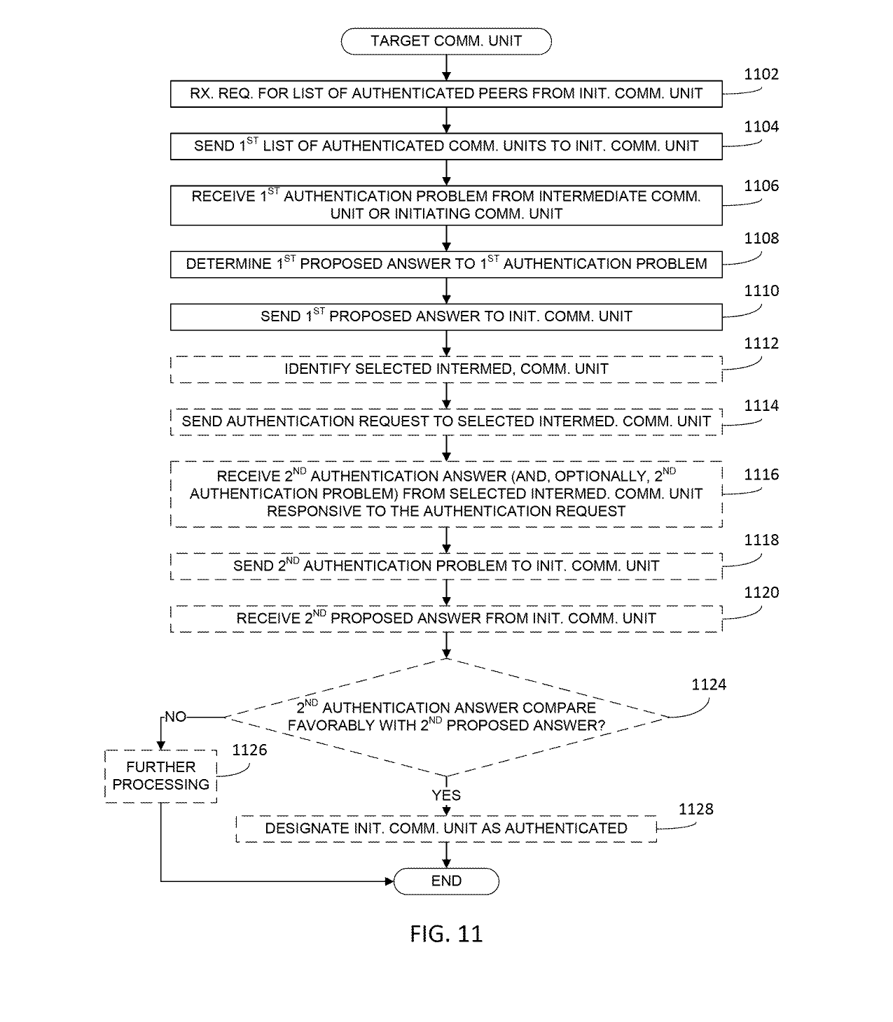

Referring now to FIG. 9, authentication processing by an initiating communication unit is further described. That is, the processing illustrated in FIG. 9 concerns those steps taken by an initiating communication unit to authenticate a target communication unit and, optionally, to authenticate itself back to the target communication unit. Thus, at block 902, the initiating communication unit identifies a first intermediate communication unit that may be employed in the verification process. Various techniques for accomplishing this may be used. For example, a process for identifying the first intermediate communication unit is further illustrated in FIG. 10. At block 1002, the initiating communication unit sends a request to the target communication unit for a list of authenticated peers (communication units). In response, the initiating communication unit receives a first list of authenticated communication units from the target communication unit at block 1004. The first list of authenticated communication units includes identifications of those communication units that have been previously authenticated to the target communication unit. At block 1006, processing continues where the initiating communication unit compares the first list of authenticated communication units with a second list of communication units that have been previously authenticated to the initiating communication unit. At block 1008, the initiating communication unit determines whether an identification of any communication unit in the first list matches an identification of any communication unit in the second list. If not, processing continues at block 1010 where an indication may be provided of the inability to authenticate at this time. If at least one identification of a communication unit in the first list is matched in the second list, indicating that the identified communication unit is already authenticated to both the initiating and target communication units, the initiating communication unit selects the matched identification as the first intermediate communication unit at block 1012. In an embodiment, bi-directional authentication between the initiating and target communication units and the communication units in their respective lists is presumed, i.e., the target communication unit is authenticated to each of the communication units in the first list and the initiating communication unit is authenticated to each of the communication units in the second list. However, this is not a requirement and the instant disclosure is not limited in this regard. Though FIG. 10 illustrates a particular technique that permits the initiating communication unit to identify an intermediate communication unit, the instant disclosure is not limited in this regard and other techniques may be employed for this purpose.

An example of this is illustrated in FIG. 13 (which represents a continuation of the illustration in FIG. 8) where the initiating communication unit, Dawn, sends a request for the list of authenticated peers to the target communication unit, Charlie. In response, Charlie sends the first list back to Dawn, as shown. Note that, at this point, the connector terminators for the connection between Dawn and Charlie, shown as squares, reflect the fact that neither Dawn or Charlie is authenticated to the other.

Referring once again to FIG. 9, having identified the first intermediate communication unit, processing continues at block 904 where the initiating communication unit sends a first authentication request to the first intermediate communication unit. In an embodiment, the first authentication request includes an identifier of the target communication unit that the initiating communication unit seeks to authenticate. In response, at block 906, the initiating communication unit receives at least a first authentication answer to a first authentication problem generated by the intermediate communication unit. As described in greater detail below, the first authentication problem comprises a message that poses a question to the target communication unit and that the target communication unit is capable of successfully interpreting based on a shared secret that the target communication unit shares with the intermediate communication unit. In an embodiment, the intermediate communication unit sends the first authentication problem to the target communication unit responsive to the first authentication request. In an alternative embodiment, the initiating communication unit may instead receive, at block 908, the first authentication problem from the intermediate communication unit and, at block 910, forward the first authentication problem to the target communication unit. These alternative embodiments are further illustrated in FIGS. 14 and 15. In FIG. 14, the initiating communication unit, Dawn, sends the first authentication request to the first intermediate communication unit, Alice. In turn, in this case, Alice direct provides the first authentication problem to Charlie and further sends the first authentication answer to Dawn. In keeping with the alternate embodiment, FIG. 15 illustrates the case where, in response to the first authentication request, Alice instead sends both the first authentication problem and the first authentication answer to Dawn. In this case, Dawn then sends the first authentication problem to Charlie.

As noted, the first authentication problem poses a question that the target communication unit is capable of answering based on the share secret it shares with the intermediate communication unit. In this manner, and with reference to FIG. 14 et seq., Alice is essentially telling Dawn that, if Charlie can provide you the correct answer to the first authentication problem, then that Charlie is the same at the Charlie that has been authenticated to Alice. Generally, the first authentication problem may take on a variety of forms that fit this need. For example, a naïve authentication problem can be an encrypted message. If Charlie can decrypt the ciphertext, C, to get plaintext, P, then Charlie answers correctly. Similarly, the authentication problem could be a MAC over a string, S, such that Charlie is asked to likewise provide the MAC of string S. However, such simple approaches are relative weak and vulnerable to cryptanalytic attacks.

Preferably, the authentication problem meets a number of criteria. First, the authentication problem should not reveal the shared secret between the initiating and target communication units. Additionally, the authentication problem should be tailored by the intermediate communication unit for the initiating intermediate communication unit. That is, the target communication unit must know that the intermediate communication unit is posing the authentication problem on behalf of the initiating communication unit. Furthermore, the authentication problem should be reasonably immune to replays over time, i.e., it should incorporate a TTL mechanism. Further still, the intermediate communication unit shouldn't be able to help the target communication unit fraudulently authenticate. One potential mitigation would be to indicate a stronger authentication scheme based on the number of different authentication problems from different intermediate communication units. That is, in some instances, a stronger degree of authentication can be achieved, and any potential fraud by an intermediate communication unit is mitigated, if authentication problems from multiple intermediate communication units are employed.

In the general case, the authentication problem, P, contains a set of parameters, and an answer, A, that is a bit string that represents the answer. An example of a construction of an authentication problem is a data structure that comprises the elements listed in Table 1 below.

TABLE 1

| ELEMENT | DESCRIPTION |
|---|---|
| Random Salt | A random bitstring or suitable constant that the |
| | intermediate communication unit includes to |
| | randomize any hashing. |
| Version Number | Version number for the data structure embodying |
| | the authentication problem. |
| Cryptographic | An identifier of a cryptographic algorithm that |
| Algorithm Identifier | will be used to compute the authentication |
| | problem answer. For example, where the answer |
| | is a MAC, this field could specify HMAC/Skein- |
| | 51-512. |
| Authentication | Identifier of the communication unit that is |
| | creating the authentication |
| Problem Creator | problem on behalf of the initiating communication |
| Identifier | unit, i.e., the intermediate communication unit. |
| Authentication | Identifier of the communication unit that issued |
| Problem Requestor | the authentication request, i.e., the initiating |
| | communication unit. |
| TTL | Indicator of when the authentication problem was |
| | created. |
| MAC | A MAC that is computed using the specified |
| | algorithm over the whole of the preceding fields |
| | in the data structure and based on the shared |
| | secret between the initiating and target |
| | communication units. |

In this case, the authentication problem answer is a MAC computed, using the noted algorithm, over the entirety of the data structure of Table 1, including the final MAC element listed in Table 1.

Regardless of the particular form of the first authentication problem and how it is ultimately provided to the target communication unit, processing continues at block 912 where the initiating communication unit receives a first proposed answer from the target communication unit. An example of this is illustrated in FIG. 16 where Charlie sends the first proposed answer (in response to the provided first authentication problem) directly to Dawn. In an embodiment, a message descriptor or similar mechanism may be used to identify the message received by Dawn as a proposed answer. Thereafter, at block 914, the initiating communication unit compares the first authentication answer (previously received from the intermediate communication unit) with the first proposed authentication answer. If the two answers do not match at block 914, processing continues at block 916 where an indication of a failed authentication may be provided. If the two answers do match at block 914, the initiating communication unit designates the target communication unit as being authenticated. This is illustrated in FIG. 16 where the connection terminator associated with Dawn is changed to a circle, indicating that the target communication unit for this connection, i.e., Charlie, has been authenticated to Dawn. It is noted that, at this point, the initiating communication unit, Dawn, is not yet authenticated to Charlie as indicated by the square-shaped connection terminator associated with Charlie.

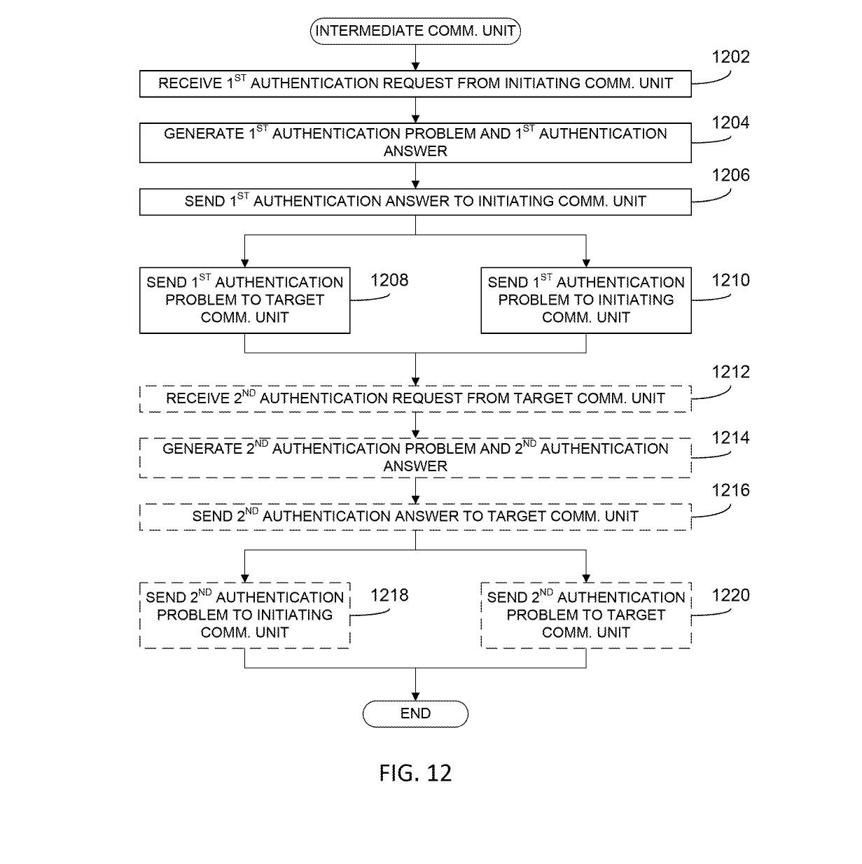

To complete the authentication of the initiating communication unit to the target communication unit, if needed or desired, processing optionally continues at blocks 920-924 where roles of the initiating and target communication units as described above relative to FIG. 9 are reversed. That is, at block 920, the initiating communication unit receives a second authentication problem, preferably structurally and functionally equivalent to the first authentication problem as described above, from the first intermediate communication unit or another intermediate communication unit. In this case, the second authentication problem is configured to be answered specifically by the initiating communication unit. Thus, at block 922, the initiating communication unit determines an answer to the second authentication problem and, at block 924, sends the resulting second proposed answer back to the target communication unit. The largely complementary operation of the target communication unit during authentication operation is further described below with reference to FIG. 11.

Referring now to FIG. 11, authentication processing by a target communication unit is further described. That is, the processing illustrated in FIG. 11 concerns those steps taken by a target communication unit to authenticate itself to an initiating communication unit and, optionally, to authenticate the initiating communication unit back to the target communication unit. Thus, the complementary steps to the process for identifying the first intermediate communication unit are illustrated at steps 1102 and 1104. Particularly, at block 1102, the target communication unit receives the request for the list of authenticated peers from the initiating communication unit and, at block 1104, the target communication unit sends the first list of authenticated communication units to the initiating communication unit. Thereafter, at block 1106, the target communication unit receives the first authentication problem from either the first intermediate communication unit or the initiating communication unit. At block 1108, the target communication unit determines a first proposed answer to the first authentication problem as described above and, at block 1110, sends the first proposed answer to the initiating communication unit. Presuming that the first proposed answer is correct, the target communication unit will be authenticated to the initiating communication unit as described above relative to FIG. 9.

To complete the authentication of the initiating communication unit to the target communication unit, if needed or desired, processing optionally continues at blocks 1112-1126 where roles of the initiating and target communication units as described above relative to FIG. 9 are reversed. Thus, the processing of blocks 1112-1126 are essentially the same as the processing of blocks 902-918 with the roles of the initiating and target communication units reversed. Thus, at block 1112, a selected intermediate communication unit can be identified using essentially the same process as described above relative to FIG. 10. It is noted that the selected intermediate communication unit can be the same as the first intermediate communication unit, though this is not a requirement. Thereafter, at block 1114, the target communication unit sends a second authentication request to the selected intermediate communication unit, which second authentication request includes an identifier of the initiating communication unit. In response, the target communication unit receives from the selected intermediate communication unit, at block 1116, at least a second authentication answer to a second authentication problem and, optionally, the second authentication problem as well. When the target communication unit receives the second authentication problem from the selected intermediate communication unit, processing continues at block 1118 where the target communication unit sends the second authentication problem to the initiating communication unit. As described above, the selected intermediate communication unit could alternatively send the second authentication problem directly to the initiating communication unit. These alternatives are illustrated in FIGS. 17 and 18. In FIG. 17, the target communication unit, Charlie, sends the second authentication request to Alice and, in response Alice sends the second authentication answer to Charlie and the second authentication problem to the initiating communication unit, Dawn. Alternatively, in FIG. 18, in response to the second authentication request, Alice sends the both the second authentication answer and the second authentication problem to Charlie, and Charlie in turn sends the second authentication problem to Dawn.

Regardless of how the initiating communication unit receives the second authentication problem, at block 1120, the target communication unit receives a second proposed answer from the initiating communication unit. At block 1124, the target communication unit determines if the second proposed answer compares favorably (i.e., matches) the second authentication answer. If not, processing continues at block 1126, where an indication of a failed authentication may be provided. If the comparison is favorable, processing continues at block 1128 where the target communication unit designates the initiating communication unit as being authenticated. This is illustrated in FIG. 19 where, in response to the second proposed answer received from Dawn, Charlie designates Dawn as being authenticated as indicated by the square connection terminator associate with Charlie. At this time, then, the connection between Dawn and Charlie has been verified and authenticated by both communication units.

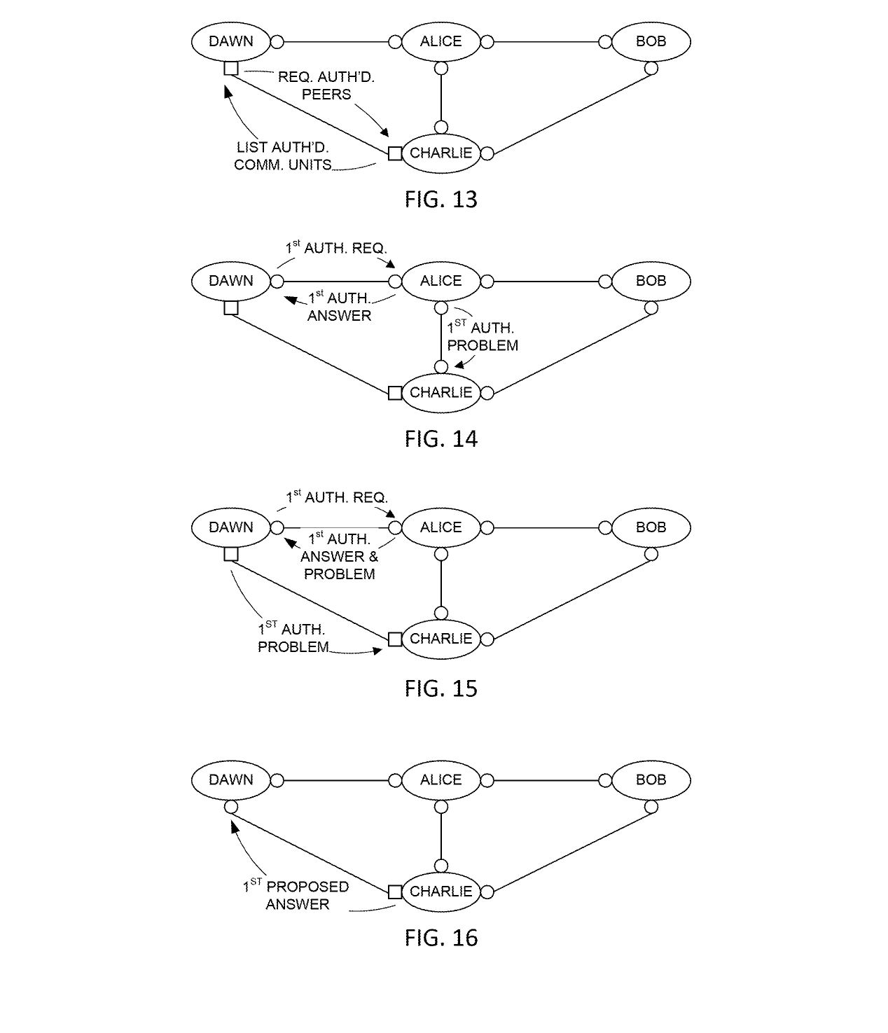

Finally, with reference to FIG. 12, authentication processing by an intermediate communication unit is further described. That is, the processing illustrated in FIG. 12 concerns those steps taken by an intermediate communication unit to assist in the authentication of a target communication unit to an initiating communication unit and, optionally, vice versa. Thus, at block 1202, the intermediate communication unit receive the first authentication request from the initiating communication unit, which request includes an identifier of the target communication unit. In response, the intermediate communication unit generates a first authentication problem and a first authentication answer, as described above, based on the identifier of the target communication unit. That is, based on the identifier of the target communication unit, the intermediate communication unit knows to use it shared secret for the target communication unit when constructing the first authentication problem and first authentication answer. At block 1206, the intermediate communication unit sends the first authentication answer to the initiating communication unit. Thereafter, processing may proceed along either of two parallel paths denoted by blocks 1208 and 1210. At block 1208, the intermediate communication unit sends the first authentication problem to the target communication unit whereas, at block 1210, the intermediate communication unit sends the first authentication problem to the initiating communication unit.

In order to facilitate the opposite verification process, i.e., verification of the initiating communication unit to the target communication unit, the processing of blocks 1202-1210 is repeated with the roles reversed at blocks 1212-1220. For the sake of convenience, it is assumed the first intermediate communication unit, as described relative to FIG. 9 and the selected intermediate communication unit, as described relative to FIG. 11, are the same intermediate communication unit in FIG. 12. However, in practice, as noted previously, this is not a requirement and the separate processing of blocks 1202-1210 and blocks 1212-1220 could be performed by separate intermediate communication units. Regardless, at block 1212, the intermediate communication unit receives a second authentication request from the target communication unit and, in response thereto, generates a second authentication problem and a second authentication answer at block 1214. As before, the intermediate communication unit sends the second authentication answer to the target communication unit at block 1216. Thereafter, processing may proceed along either of two parallel paths denoted by blocks 1218 and 1220. At block 1218, the intermediate communication unit sends the second authentication problem to the intermediate communication unit whereas, at block 1220, the intermediate communication unit sends the first authentication problem to the target communication unit.

While particular preferred embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A method for authenticating a target communication unit in a network of communication units, wherein authentication comprises confirming identity of a communication unit within the network of communication units, the method comprising:
sending, by an initiating communication unit, an authentication request to a first intermediate communication unit that the initiating communication unit previously designated as authenticated, the authentication request including an identifier of the target communication unit;
receiving, by the initiating communication unit from the first intermediate communication unit in response to the authentication request, a first authentication answer to a first authentication problem, the first authentication problem being answerable by the target communication unit based on authentication of the target communication unit to the intermediate communication unit;
receiving, by the initiating communication unit from the target communication unit, a first proposed answer to the first authentication problem; and
when the first authentication answer compares favorably with the first proposed answer, designating, by the initiating communication unit, the target communication unit as being authenticated.

2. The method of claim 1, further comprising:
sending, by the initiating communication unit to the target communication unit, a request for a list of authenticated peers; and
receiving, by the initiating communication unit from the target communication unit in response to the request for the list of authenticated peers, a first list of communication units that are authenticated to the target communication unit, the first list including an identification of the first intermediate communication unit.

3. The method of claim 2, further comprising, prior to sending the authentication request to the first intermediate communication unit:
comparing, by the initiating communication unit, the first list with a second list of communication units that are authenticated to the initiating communication unit; and
determining, by the initiating communication unit, that the identification of the first intermediate communication unit in the first list is matched in the second list.

4. The method of claim 1, wherein the first authentication answer is based on a first shared secret between the first intermediate communication unit and the target communication unit.

5. The method of claim 4, wherein the first authentication problem is encrypted data and the first authentication answer is decrypted data based on decryption of the encrypted data using the first shared secret.

6. The method of claim 4, wherein the first authentication problem is a data structure and the first authentication answer is a first message authentication code based on the data structure and the first shared secret.

7. The method of claim 6, wherein the data structure comprises: a random salt, an authentication problem version identifier, a cryptographic algorithm identifier; an identifier of the first intermediate communication unit, an identifier of the initiating communication unit, a timestamp and a second message authentication code based on the random salt, the authentication problem version identifier, the cryptographic algorithm identifier, the identifier of the first intermediate communication unit, the identifier of the initiating communication unit and the time stamp.

8. The method of claim 1, further comprising:
receiving, by the initiating communication unit from the first intermediate communication unit in response to the authentication request, the first authentication problem; and
sending, by the initiating communication unit to the target communication unit, the first authentication problem.

9. The method of claim 1, further comprising:
receiving, by the initiating communication unit from either the target communication unit, the first intermediate communication unit or another intermediate communication unit, a second authentication problem, the second authentication problem being answerable by the initiating communication unit based on authentication of the initiating communication unit to the first intermediate communication unit or the other intermediate communication unit;
determining, by the initiating communication unit, a second proposed answer to the second authentication problem; and
sending, by the initiating communication unit to the target communication unit, the second proposed answer.

10. A method for authenticating a target communication unit in a network of communication units, wherein authentication comprises confirming identity of a communication unit within the network of communication units, the method comprising:
receiving, by the target communication unit from either an intermediate communication unit or an initiating communication unit, a first authentication problem, the first authentication problem being answerable by the target communication unit based on authentication of the target communication unit to the intermediate communication unit;
determining, by the target communication unit, a first proposed answer to the first authentication problem; and
sending, by the target communication unit to the initiating communication unit, the first proposed answer.

11. The method of claim 10, further comprising:
receiving, by the target communication unit from the initiating communication unit, a request for a list of authenticated peers; and
sending, by the target communication unit to the initiating communication unit in response to the request for the list of authenticated peers, a first list of communication units that are authenticated to the target communication unit, the list including an identification of the intermediate communication unit.

12. The method of claim 10, wherein the first proposed answer is based on a first shared secret between the intermediate communication unit and the target communication unit.

13. The method of claim 12, wherein the first authentication problem is encrypted data and the proposed answer is decrypted data based on decryption of the encrypted data using the first shared secret.

14. The method of claim 12, wherein the first authentication problem is a data structure and the proposed answer is a first message authentication code based on the data structure and the first shared secret.

15. The method of claim 14, wherein the data structure comprises: a random salt, an authentication problem version identifier, a cryptographic algorithm identifier; an identifier of the intermediate communication unit, an identifier of the initiating communication unit, a timestamp and a second message authentication code based on the random salt, the authentication problem version identifier, the cryptographic algorithm identifier, the identifier of the intermediate communication unit, the identifier of the initiating communication unit and the time stamp.

16. The method of claim 10, further comprising:
sending, by the target communication unit, an authentication request to a selected intermediate communication unit that the target communication unit previously designated as authenticated;
receiving, by the target communication unit from the selected intermediate communication unit in response to the authentication request, at least a second authentication answer to a second authentication problem, the second authentication problem being answerable by the initiating communication unit based on authentication of the initiating communication unit to the selected intermediate communication unit;
receiving, by the target communication unit from the initiating communication unit, a second proposed answer to the second authentication problem; and
when the second authentication answer compares favorably with the second proposed answer, designating, by the target communication unit, the initiating communication unit as being authenticated.

17. The method of claim 16, further comprising:
receiving, by the target communication unit from the selected intermediate communication unit in response to the authentication request, the second authentication problem; and
sending, by the target communication unit to the initiating communication unit, the second authentication problem.

18. The method of claim 16, further comprising:
sending, by the target communication unit to the initiating communication unit, a request for a list of authenticated peers; and
receiving, by the target communication unit from the initiating communication unit in response to the request for the list of authenticated peers, a first list of communication units that are authenticated to the initiating communication unit, the first list including an identification of the selected intermediate communication unit.

19. The method of claim 18, further comprising, prior to sending the authentication request to the selected intermediate communication unit:
comparing, by the target communication unit, the first list with a second list of communication units that are authenticated to the target communication unit; and
determining, by the target communication unit, that the identification of the selected intermediate communication unit in the first list is matched in the second list.

20. A method for supporting authentication of a target communication unit in a network of communication units, wherein authentication comprises confirming identity of a communication unit within the network of communication units, the method comprising:
receiving, by an intermediate communication unit, a first authentication request from an initiating communication unit, wherein the initiating communication unit previously designated the intermediate communication unit as authenticated, the first authentication request including an identifier of the target communication unit;
generating, by the intermediate communication unit, a first authentication problem and a first authentication answer to the first authentication problem, the first authentication problem being answerable by the target communication unit based on authentication of the target communication unit to the intermediate communication unit; and
sending, by the intermediate communication unit, the first authentication answer to the initiating communication unit.

21. The method of claim 20, further comprising:
sending, by the intermediate communication unit, the first authentication problem to the target communication unit.

22. The method of claim 20, further comprising:
sending, by the intermediate communication unit, the first authentication problem to the initiating communication unit.

23. The method of claim 20, wherein the first authentication answer is based on a first shared secret between the intermediate communication unit and the target communication unit.

24. The method of claim 23, wherein the first authentication problem is encrypted data and the first authentication answer is decrypted data based on decryption of the encrypted data using the first shared secret.

25. The method of claim 23, wherein the first authentication problem is a data structure and the first authentication answer is a first message authentication code based on the data structure and the first shared secret.

26. The method of claim 25, wherein the data structure comprises: a random salt, an authentication problem version identifier, a cryptographic algorithm identifier; an identifier of the intermediate communication unit, an identifier of the initiating communication unit, a timestamp and a second message authentication code based on the random salt, the authentication problem version identifier, the cryptographic algorithm identifier, the identifier of the intermediate communication unit, the identifier of the initiating communication unit and the time stamp.

27. The method of claim 20, further comprising:
receiving, by the intermediate communication unit, a second authentication request from the target communication unit, wherein the target communication unit previously designated the intermediate communication unit as authenticated, the second authentication request including an identifier of the initiating communication unit;
generating, by the intermediate communication unit, a second authentication problem and a second authentication answer to the second authentication problem, the second authentication problem being answerable by the initiating communication unit based on authentication of the initiating communication unit to the intermediate communication unit; and
sending, by the intermediate communication unit, the second authentication answer to the target communication unit.

28. The method of claim 27, further comprising:
sending, by the intermediate communication unit, the second authentication problem to the initiating communication unit.

29. The method of claim 27, further comprising:
sending, by the intermediate communication unit, the second authentication problem to the target communication unit.

30. An initiating communication unit operative within a network of communication units, the initiating communication unit comprising:
a processor;
a storage device, operatively connected to the processor, having stored thereon executable instructions that, when executed by the processor, are operative to cause the processor to:
send an authentication request to a first intermediate communication unit previously designated as authenticated, the authentication request including an identifier of a target communication unit, wherein authentication comprises confirming identity of a communication unit within the network of communication units;
receive, from the first intermediate communication unit in response to the authentication request, a first authentication answer to a first authentication problem, the first authentication problem being answerable by the target communication unit based on authentication of the target communication unit to the intermediate communication unit;
receive, from the target communication unit, a first proposed answer to the first authentication problem; and
when the first authentication answer compares favorably with the first proposed answer, designate the target communication unit as being authenticated.

31. The initiating communication unit of claim 30, the storage device further comprising executable instructions that, when executed by the processor, cause the processor to:
send, to the target communication unit, a request for a list of authenticated peers; and
receive, from the target communication unit in response to the request for the list of authenticated peers, a first list of communication units that are authenticated to the target communication unit, the first list including an identification of the first intermediate communication unit.

32. The initiating communication unit of claim 31, the storage device further comprising executable instructions that, when executed by the processor, cause the processor to, prior to sending the authentication request to the first intermediate communication unit:
compare the first list with a second list of communication units that are authenticated to the initiating communication unit; and
determine that the identification of the first intermediate communication unit in the first list is matched in the second list.

33. The initiating communication unit of claim 30, wherein the authentication answer is based on a first shared secret between the first intermediate communication unit and the target communication unit.

34. The initiating communication unit of claim 33, wherein the authentication problem is encrypted data and the authentication answer is decrypted data based on decryption of the encrypted data using the first shared secret.

35. The initiating communication unit of claim 33, wherein the authentication problem is a data structure and the authentication answer is a first message authentication code based on the data structure and the first shared secret.

36. The initiating communication unit of claim 35, wherein the data structure comprises: a random salt, an authentication problem version identifier, a cryptographic algorithm identifier; an identifier of the first intermediate communication unit, an identifier of the initiating communication unit, a timestamp and a second message authentication code based on the random salt, the authentication problem version identifier, the cryptographic algorithm identifier, the identifier of the first intermediate communication unit, the identifier of the initiating communication unit and the time stamp.

37. The initiating communication unit of claim 30, the storage device further comprising executable instructions that, when executed by the processor, cause the processor to:
receive, from the first intermediate communication unit in response to the authentication request, the first authentication problem; and
send the first authentication problem to the target communication unit.

38. The initiating communication unit of claim 30, the storage device further comprising executable instructions that, when executed by the processor, cause the processor to:
receive, from either the target communication unit, the first intermediate communication unit or another intermediate communication unit, a second authentication problem answerable by the initiating communication unit based on authentication of the initiating communication unit to the first intermediate communication unit or the other intermediate communication unit;
determine a second proposed answer to the second authentication problem; and
send the second proposed answer to the target communication unit.

39. A target communication unit operative within a network of communication units, the target communication unit comprising:
a processor;
a storage device, operatively connected to the processor, having stored thereon executable instructions that, when executed by the processor, are operative to cause the processor to:
receive, from either an intermediate communication unit or an initiating communication unit, a first authentication problem answerable by the target communication unit based on authentication of the target communication unit to the intermediate communication unit, wherein authentication comprises confirming identity of a communication unit within the network of communication units;
determine a first proposed answer to the first authentication problem; and
send the first proposed answer to the initiating communication unit.

40. The target communication unit of claim 39, the storage device further comprising executable instructions that, when executed by the processor, cause the processor to:
receive, from the initiating communication unit, a request for a list of authenticated peers; and
send, to the initiating communication unit in response to the request for the list of authenticated peers, a first list of communication units that are authenticated to the target communication unit, the list including an identification of the intermediate communication unit.

41. The target communication unit of claim 39, wherein the first proposed answer is based on a first shared secret between the intermediate communication unit and the target communication unit.

42. The target communication unit of claim 41, wherein the first authentication problem is encrypted data and the proposed answer is decrypted data based on decryption of the encrypted data using the first shared secret.

43. The target communication unit of claim 41, wherein the first authentication problem is a data structure and the proposed answer is a first message authentication code based on the data structure and the first shared secret.

44. The target communication unit of claim 43, wherein the data structure comprises: a random salt, an authentication problem version identifier, a cryptographic algorithm identifier; an identifier of the intermediate communication unit, an identifier of the initiating communication unit, a timestamp and a second message authentication code based on the random salt, the authentication problem version identifier, the cryptographic algorithm identifier, the identifier of the intermediate communication unit, the identifier of the initiating communication unit and the time stamp.

45. The target communication unit of claim 39, the storage device further comprising executable instructions that, when executed by the processor, cause the processor to:
send an authentication request to a selected intermediate communication unit that the target communication unit previously designated as authenticated;
receive, from the selected intermediate communication unit in response to the authentication request, at least a second authentication answer to a second authentication problem, the second authentication problem being answerable by the initiating communication unit based on authentication of the initiating communication unit to the selected intermediate communication unit;
receive, from the initiating communication unit, a second proposed answer to the second authentication problem; and
when the second authentication answer compares favorably with the second proposed answer, designate the initiating communication unit as being authenticated.

46. The target communication unit of claim 45, the storage device further comprising executable instructions that, when executed by the processor, cause the processor to:
receive, from the selected intermediate communication unit in response to the authentication request, the second authentication problem; and
send, to the initiating communication unit, the second authentication problem.

47. The target communication unit of claim 45, the storage device further comprising executable instructions that, when executed by the processor, cause the processor to:
send, to the initiating communication unit, a request for a list of authenticated peers; and
receive, from the initiating communication unit in response to the request for the list of authenticated peers, a first list of communication units that are authenticated to the initiating communication unit, the first list including an identification of the selected intermediate communication unit.

48. The initiating communication unit of claim 47, the storage device further comprising executable instructions that, when executed by the processor, cause the processor to, prior to sending the authentication request to the selected intermediate communication unit:
compare the first list with a second list of communication units that are authenticated to the target communication unit; and
determine that the identification of the selected intermediate communication unit in the first list is matched in the second list.

49. An intermediate communication unit operative within a network of communication units, the intermediate communication unit comprising:
a processor;
a storage device, operatively connected to the processor, having stored thereon executable instructions that, when executed by the processor, are operative to cause the processor to:
receive a first authentication request from an initiating communication unit, wherein the initiating communication unit previously designated the intermediate communication unit as authenticated, the first authentication request including an identifier of the target communication unit, wherein authentication comprises confirming identity of a communication unit within the network of communication units;
generate a first authentication problem and a first authentication answer to the first authentication problem, the first authentication problem being answerable by the target communication unit based on authentication of the target communication unit to the intermediate communication unit; and
send the first authentication answer to the initiating communication unit.

50. The intermediate communication unit of claim 49, the storage device further comprising executable instructions that, when executed by the processor, cause the processor to:
send the first authentication problem to the target communication unit.

51. The intermediate communication unit of claim 49, the storage device further comprising executable instructions that, when executed by the processor, cause the processor to:
send the first authentication problem to the initiating communication unit.

52. The intermediate communication unit of claim 49, wherein the first authentication answer is based on a first shared secret between the intermediate communication unit and the target communication unit.

53. The intermediate communication unit of claim 52, wherein the first authentication problem is encrypted data and the first authentication answer is decrypted data based on decryption of the encrypted data using the first shared secret.

54. The intermediate communication unit of claim 52, wherein the first authentication problem is a data structure and the first authentication answer is a first message authentication code based on the data structure and the first shared secret.

55. The intermediate communication unit of claim 54, wherein the data structure comprises: a random salt, an authentication problem version identifier, a cryptographic algorithm identifier; an identifier of the intermediate communication unit, an identifier of the initiating communication unit, a timestamp and a second message authentication code based on the random salt, the authentication problem version identifier, the cryptographic algorithm identifier, the identifier of the intermediate communication unit, the identifier of the initiating communication unit and the time stamp.

56. The intermediate communication unit of claim 49, the storage device further comprising executable instructions that, when executed by the processor, cause the processor to:
receive a second authentication request from the target communication unit, wherein the target communication unit previously designated the intermediate communication unit as authenticated, the second authentication request including an identifier of the initiating communication unit;
generate a second authentication problem and a second authentication answer to the second authentication problem, the second authentication problem being answerable by the initiating communication unit based on authentication of the initiating communication unit to the intermediate communication unit; and
send the second authentication answer to the target communication unit.

57. The intermediate communication unit of claim 56, the storage device further comprising executable instructions that, when executed by the processor, cause the processor to:
send the second authentication problem to the initiating communication unit.

58. The intermediate communication unit of claim 56, the storage device further comprising executable instructions that, when executed by the processor, cause the processor to:
send the second authentication problem to the target communication unit.
